(19) United States
(12) Patent Application Publication
(10) Pub. No.: US 2020/0167668 A1
(43) Pub. Date: May 28, 2020

(54) DYNAMIC RULE EXECUTION ORDER

(71) Applicant: SAP SE, Walldorf (DE)

(72) Inventor: Wei Chen, Shanghai (CN)

(21) Appl. No.: 16/201,232

(22) Filed: Nov. 27, 2018

(51) Int. Cl. G06N 5/02

(52) U.S. Cl. CPC G06N 5/025

(57) ABSTRACT

A system includes reception of an instruction to evaluate a rule definition, the rule definition associated with one or more branches, and each branch associated with one or more conditions, determination of whether a first condition of a first branch of the rule definition is TRUE, and updating of a first counter associated with the rule definition and the first condition of the first branch if the first condition is determined as TRUE.

### BACKGROUND

Enterprise software systems receive, generate, and store data related to many aspects of an enterprise. Such systems often provide applications which may provide functionality to users based on the data. For example, a Human Resources Management application may allow a user to create vacation schedules, organizational charts, and expense reports based on stored employee data.

Applications may use pre-defined rules to determine whether to execute certain actions. The rules are typically defined in the format: IF <condition> THEN<action>. A rule may include several IF <condition> THEN <action> statements (or branches), each of which is associated with an alternative scenario. Moreover, each branch may include multiple conditions which define the scenario associated with the branch.

In a typical system, evaluation of a rule involves evaluating the branches of the rule sequentially until all the conditions of a branch are deemed satisfied. The evaluation proceeds quickly if the conditions of a first branch are satisfied. Evaluation may proceed more slowly if a rule includes many branches and/or many conditions per branch, and only the conditions of a later-evaluated branch are satisfied. Systems are needed to improve the performance of systems which evaluate multi-branch and/or multi-condition rules.

### BRIEF DESCRIPTION OF THE DRAWINGS

FIG. 1 is an architecture of a rule evaluation system according to some embodiments.

FIG. 2 illustrates a rule including branches and conditions within each branch according to some embodiments.

FIG. 3 is a flow diagram of a process according to some embodiments.

FIG. 4 is a representation of table columns for storing rule hit data according to some embodiments.

FIG. 5 depicts an AST tree corresponding to a condition expression according to some embodiments.

FIG. 6 is a user interface presenting rule hit data prior to rule re-design according to some embodiments.

FIG. 7 is a user interface presenting rule hit data after rule re-design according to some embodiments.

FIG. 8 is a block diagram of a system architecture according to some embodiments.

FIG. 9 is a block diagram of an apparatus according to some embodiments.

### DETAILED DESCRIPTION

The following description is provided to enable any person in the art to make and use the described embodiments. Various modifications, however, will remain readily-apparent to those in the art.

Generally, some embodiments facilitate reordering of rule branches and conditions in order to improve performance. Embodiments may detect and track the number of times a particular branch or condition of a rule is evaluated as TRUE, and this tracked information may be used to change (either automatically or based on a system suggestion) the order of the rule branches and/or of the conditions within the rule branches. As a result, the system resources required over time for rule evaluation may be less than otherwise needed.

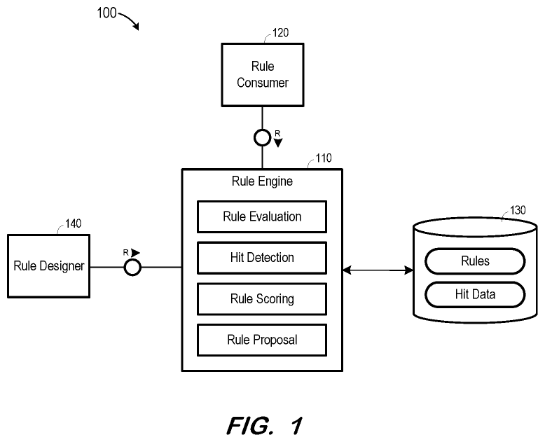

FIG. 1 is a block diagram of system 100 according to some embodiments. System 100 may implement a rule engine to perform processes as described herein.

System 100 includes rule engine 110, rule consumer 120, storage 130 and rule designer 140. Generally, rule consumer 120 may submit a request to rule engine 110 to evaluate a rule stored in storage 130. Rule designer 140 may comprise an application allowing a user to create rules including two or more branches and one or more conditions per branch, where each branch is associated with an action to be performed if all conditions of the branch are evaluated as TRUE.

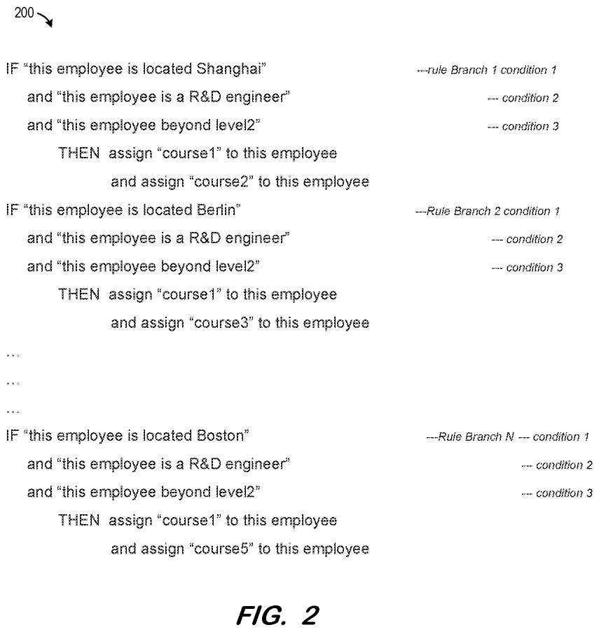

FIG. 2 illustrates rule 200 according to some embodiments. Three branches of rule 200 are shown, although rule 200 may include more than three branches. Each branch includes three conditions although embodiments are not limited to three conditions or to an equal number of conditions per branch. Each branch is also associated with two actions although embodiments are not limited to two actions conditions or to an equal number of actions per branch.

Rule engine 110 includes a rule evaluation component to evaluate rules. Evaluation of a rule may include evaluation of the conditions and branches of a rule to determine one or more actions to be performed. As described above, Branch 1 of rule 200 is evaluated first, and the conditions of Branch 1 are evaluated in the order presented (i.e., first condition 1, then condition 2, then condition 3). When all conditions of a branch evaluate as TRUE, the one or more actions associated with the branch are processed. For example, rule engine 110 may perform the determined action(s), return the action(s) to rule consumer 120 for performance, or request another component to perform the action.

Rule engine 110 also includes a hit detection component to detect the conditions and branches which the rule evaluation component evaluates as TRUE during rule evaluation. The hit detection component may record each TRUE evaluation in the hit data of storage 130 along with an identifier of the condition or branch which was evaluated as TRUE. Details of the detection and storage of hit data according to some embodiments will be provided below.

Based on the hit data, a rule scoring component of rule engine 110 may determine a score associated with a rule based on the configuration of the branches and conditions of the rule. A rule proposal component may propose rule reconfiguration to rule designer 140 based on the determined scores. For example, the rule proposal component may propose moving a branch to the beginning of a rule (where it will be evaluated first) because the branch has recently been evaluated as TRUE more often than other branches of the rule. If this trend continues, then future evaluations of the rule will proceed more quickly than the prior evaluations because the evaluations will end as soon as the now-first branch evaluates as TRUE.

Rule engine 110 may be a service, in which case rule consumer 120 may comprise a separate application, or may be integrated within an application, in which case rule consumer 120 comprises another component of the application.

System 100 may be implemented using any architecture that is or becomes known, including but not limited to distributed, on-premise, cloud-based and hybrid architectures. Embodiments are not limited to system 100 or to a database architecture. Each component of system 100 may be implemented at least in part in computer hardware, in program code and/or in one or more computing systems executing such program code as is known in the art. Such a computing system may include one or more processing units which execute processor-executable program code stored in a memory system.

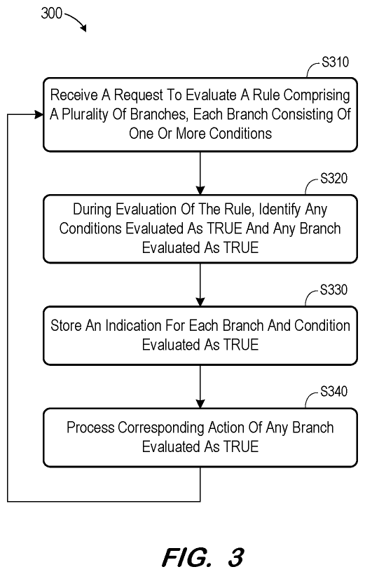

FIG. 3 comprises a flow diagram of process 300 according to some embodiments. Process 300 may be executed to evaluate rules and record hit data according to some embodiments.

In some embodiments, various hardware elements of system 100 execute program code to perform process 300. Process 300 and all other processes mentioned herein may be embodied in computer-executable program code read from one or more of non-transitory computer-readable media, such as a non-volatile random access memory, a hard disk, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, a request is received to evaluate a rule. As described above, the rule includes one or more branches, and each branch consists of one or more conditions. As also described above, evaluation of a rule comprises evaluating the conditions of a first branch of the rule and, if the conditions of the first branch are not all evaluated as TRUE, evaluating the conditions of a next branch of the rule. Evaluation continues in this manner until either all conditions of a branch are evaluated as TRUE, or all branches of the rule have been evaluated.

During evaluation of the rule at S320, conditions which are evaluated as TRUE and any branch that is evaluated as TRUE are identified. At S330, an indication is stored for any branches and conditions evaluated as TRUE at S320. The indication may be stored as hit data as described above.

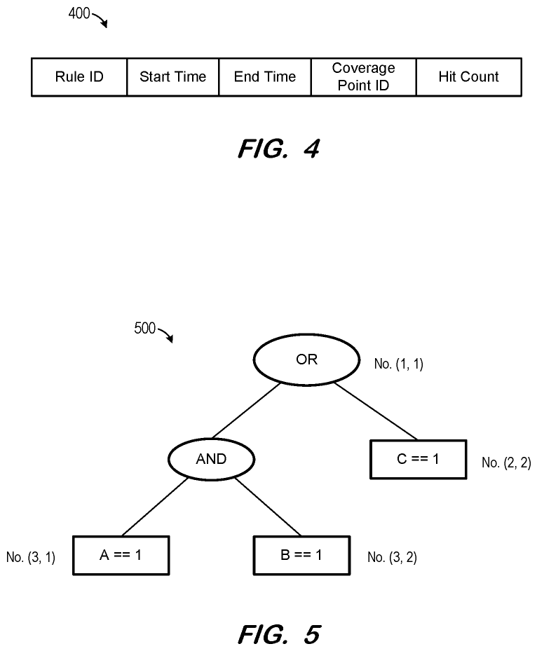

FIG. 4 illustrates stored indications according to some embodiments. Table 400 may store hit data which is stored in storage 130 along with rules, but embodiments are not limited thereto. Each record of table 400 specifies a Rule ID uniquely identifying a rule, a Start Time and an End Time of the period during which the hit data of the row is collected, a Coverage Point ID identifying a branch or a condition of the associated rule, and a Hit Count indicating the total number of times the branch or condition of the Coverage Point ID was evaluated as true during the period defined by the Start Time and the End Time.

Accordingly, each rule identified by a Rule ID may be associated with one or more collection periods defined by a Start Time and End Time. Each collection period, in turn, is associated with a Coverage Point ID for every branch and condition in the rule. Finally, each Coverage Point ID of each collection period is associated with a Hit Count. In a case that system 100 is implemented in a multi-tenancy environment, table 400 may also store a Tenant ID to distinguish each tenant's rules.

Evaluation of a branch/condition at S320 and storing of an indication at S330 may proceed in any suitable manner. In the case of a branch, rule evaluation logic in the rule engine may be responsible for reporting a TRUE evaluation and passing an associated rule_identifier (i.e., Rule ID) and branch_id (i.e., Coverage Point ID). The information is used to increment an associated Hit Count counter. The following pseudocode reflects this implementation:

```
for each branch in rule definition {
  condition_result = eval(branch.if_part);
  If (condition_result) {
```

report_branch_hit(rule_identifier, branch_id);
Process original rule actions

}
}

In some embodiments, the rule definitions themselves support storage of an indication at S330. For example, prior to saving a defined rule to storage 130, an action is added to each rule branch in the rule definition which causes incrementing of the corresponding Hit Count counter. The following pseudocode reflects this implementation according to some embodiments:

IF ‘conditions'
THEN

report_branch_hit(rule_identifier, branch_id)
Process original rule actions

In the case of conditions, a Coverage Point ID for each condition in a rule may be determined. In this regard, a condition expression is a Boolean expression which produces a Boolean value when evaluated. A condition expression may be translated into an Abstract Syntax Tree (AST). FIG. 5 is an example of AST 500 corresponding to the expression: (A==1 and B==1) or C==1.

Such an AST may be iterated breadth-first to label each node as shown. The label specifies the depth of the node in the tree and the visit order among the nodes of the same depth. Once the labels are determined, the collection of hit data may proceed according to either of the above-described mechanisms, for example. More specifically, rule evaluation logic in the rule engine may report a TRUE evaluation and pass an associated rule_identifier (i.e., Rule ID) and condition_label (i.e., Coverage Point ID) to increment an associated Hit Count, as indicated by the following pseudocode:

condition_result = eval(condition);
If (condition_result) {

report_condition_hit(rule_identifier, condition_label);
Process original rule actions

}

Alternatively, when a rule definition is saved, each leaf node in the AST of each rule branch in the rule definition is changed to an AND expression. With respect to the expression of the above example, the corresponding rule branch definition may be changed to:

IF ((A==1 AND report_condition_hit(rule_identifier,
condition_label))
and (B==1 AND report_condition_hit(rule_identifier,
condition_label)))
or (C==1 AND report_condition_hit(rule_identifier,
condition_label))
THEN

Process Original Rule Actions

S340 comprises typical rule engine operation. That is, once a branch is evaluated as TRUE, any actions associated with the branch are processed. Processing may include executing the actions or instructing another component to execute the actions.

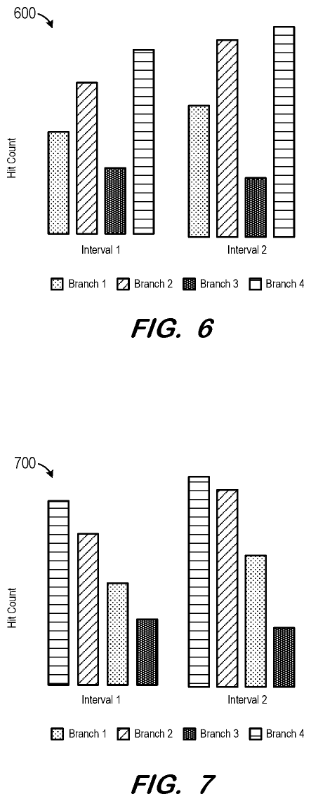

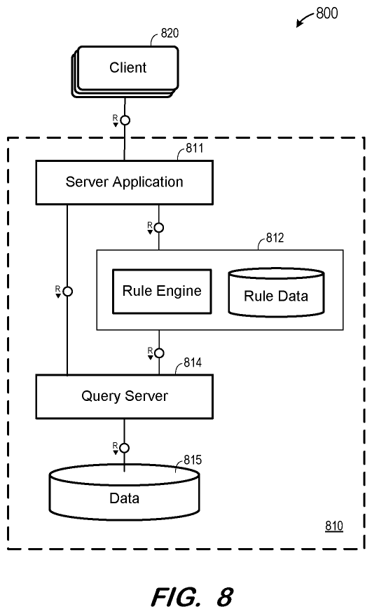

Process 300 executes to accumulate branch and condition hit data over time. According to some embodiments, a rule designer may choose to redesign a rule based on hit data associated with the rule. For example, rule designer 140 may be operated to access hit data and view a distribution of branch hits associated with a rule over various intervals. FIG. 6 illustrates histogram 600 of branch hits according to some embodiments. Histogram 600 provides an indication of how often rule evaluation must proceed to a second, third or fourth branch.

Using rule designer 140, the branches of the corresponding rule may be rearranged as shown in histogram 700. The branches have been rearranged such that the most-frequently TRUE branch is the first-evaluated branch, the second most-frequently TRUE branch is the second-evaluated branch, etc. As a result, rule evaluation may be more likely to terminate (as a result of finding a TRUE branch) earlier than otherwise.

A rule proposal component may perform such rearrangement automatically or after a designer verifies that the proposed rearranged logic remains suitable. Rule designer 140 may store the modified rule definition in storage 130 for future evaluation. The Rule ID and the Coverage Point IDs for each branch and condition may remain unchanged for purposes of hit data accumulation.

After reordering the rule branches, each rule branch in the rule definition may be further optimized based on the condition hit data. A rule definition may be proposed in which each condition within each rule is rearranged in order of ascending hit counts. More specifically, within each branch, the least-frequently TRUE condition is the first-evaluated condition, the second least-frequently TRUE condition is the second-evaluated condition, etc. Reordering of the conditions as described above may increase a likelihood that evaluation of a branch may terminate (because one of the branch conditions is determined as FALSE) sooner than otherwise.

According to some embodiments, a rule scoring component may determine a score for a rule definition according to the following equation:

$$Score = {\sum }_{n = 1}^{N} ( {P}_{n} * {D}_{n} ) + ( {P}_{n} * {W}_{N} )$$

$${P}_{n} = \frac{{H}_{n}}{{\sum }_{i = 1}^{N} {H}_{i}}$$

$${D}_{n} = {\sum }_{i = 1}^{N} {W}_{i} * {E}_{i}$$

$${W}_{n} = \frac{{\sum }_{i = 1}^{{M}_{n}} {d}_{i}}{{W}_{avg}}$$

$${E}_{n} = \frac{{\sum }_{i = 1}^{{M}_{n}} {d}_{i} * {p}_{i}}{{E}_{n}^{′}}$$

$${W}_{avg} = \frac{{\sum }_{i = 1}^{N} {\sum }_{i = 1}^{{M}_{n}} {d}_{i}}{N}$$

$${E}_{n}^{′} = {\sum }_{i = 1}^{{M}_{n}} {d}_{i}^{′} * {p}_{i}$$

where n is the branch index in the rule; N is the number of the branches in the rule; Pₙ is the possibility of reaching the n branch, which is deduced based on the branch hit coverage; Dₙ is the distance from the rule beginning to reach the n branch during the execution of the rule; Eₙ is the efficiency factor of the n branch, it measures the execution efficiency of the branch; Hₙ is the hit count of the n branch; Wₙ is the weight of cost the n^{th} branch contributes to the execution of the entire rule; W_{avg} is the average cost of evaluating a rule in rule engine; dᵢ is the distance from the beginning of branch to reach the i^{th} leaf condition node during the evaluation of the given branch; pᵢ is the possibility of reaching the i^{th} leaf condition node in the given branch, which can be deduced based on the condition hit coverage; Mₙ is the count of leaf condition nodes of the n branch; E′ₙ is predicate cost after re-arrange the conditions according to the condition hit coverage, which ideally could be the most efficient rule branch.

The above equations may be simplified by removing the condition hit data from consideration. In this case, an entire branch is treated as a single condition, making dᵢ=1, pᵢ=1, Mₙ=1, E′ₙ=1 and Wₙ=1. The Score equation then becomes:

$$Score = {\sum }_{n = 1}^{N} ( {P}_{n} * n ) + {P}_{n}$$

Rule definition scoring may be used to propose rule modifications. For example, higher-scoring configurations of branches and conditions may be proposed to a rule designer or may be automatically activated for use.

FIG. 8 is an architecture of system 800 according to some embodiments. According to system 800, server application 811 of platform 810 receives requests from one of clients 820 and responds to the requests using rule service 812 and query server 814. Server application 811 may be separated from or closely integrated with query server 814 and data 815.

In one specific example, client 820 executes an application to present a user interface to a user. The user enters a command into the user interface, and client 820 forwards a request based on the command to server application 811. In response, server application 811 may request evaluation of a rule by rule service 812. Rule service 812 may evaluate the rule as described above, for example by executing process 300. Evaluation of a rule may require querying data 815 via query server 814.

Data 815 may comprise one or more of conventional tabular data, row-based data, column-based data, and object-based data. Moreover, the data may be indexed and/or selectively replicated in an index to allow fast searching and retrieval thereof. Data 815 may support multi-tenancy to separately support multiple unrelated clients by providing multiple logical database systems which are programmatically isolated from one another.

Data 815 may comprise any query-responsive data source or sources that are or become known, including but not limited to a structured-query language (SQL) relational database management system. Data store 815 may comprise a relational database, a multi-dimensional database, an eXtendable Markup Language (XML) document, or any other data storage system storing structured and/or unstructured data. Data 815 may be distributed among several relational databases, dimensional databases, and/or other data sources. Embodiments are not limited to any number or types of data sources.

Data 815 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Each element of system 800 may be implemented at least in part in computer hardware, in program code and/or in one or more computing systems executing such program code as is known in the art. Such a computing system may include one or more processing units which execute processor-executable program code stored in a memory system.

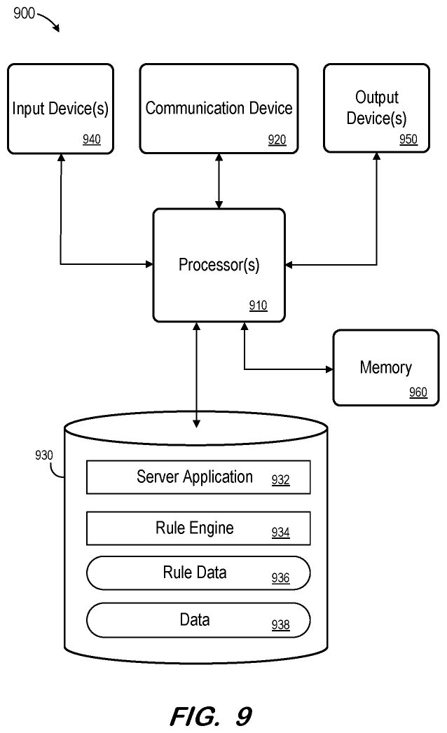

FIG. 9 is a block diagram of apparatus 900 according to some embodiments. Apparatus 900 may comprise a general-purpose computing apparatus and may execute program code to perform any of the functions described herein. Apparatus 900 may comprise an implementation of platform 810 in some embodiments. Apparatus 900 may include other unshown elements according to some embodiments.

Apparatus 900 includes processor(s) 910 operatively coupled to communication device 920, data storage device 930, one or more input devices 940, one or more output devices 950 and memory 960. Communication device 920 may facilitate communication with external devices, such as a reporting client, or a data storage device. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into apparatus 900. Output device(s) 950 may comprise, for example, a display (e.g., a display screen), a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, etc., while memory 960 may comprise Random Access Memory (RAM), Storage Class Memory (SCM) or any other fast-access memory.

Server applications 932 and rule engine 934 may comprise program code executable by processor 910 to cause apparatus 900 to perform any one or more of the processes described herein. Embodiments are not limited to execution of these processes by a single apparatus.

Rule data 936 and data 938 (either cached or a full database) may be stored in volatile memory such as memory 960. Rule data 936 may include rule definitions as described above, associated with the data sources of data 938. Data storage device 930 may also store data and other program code for providing additional functionality and/or which are necessary for operation of apparatus 900, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A computing system comprising:
a storage system storing a plurality of rule definitions, each of the plurality of rule definitions associated with one or more branches, and each branch associated with one or more conditions;
a memory storing processor-executable process steps; and
one or more processors to execute the process steps to cause the computing system to:
receive an instruction to evaluate a first one of the rule definitions;
determine whether a first condition of a first branch of a first rule definition is TRUE; and
update a first counter associated with the first rule definition and the first condition of the first branch if the first condition is determined as TRUE.

2. A computing system according to claim 1, the one or more processors to execute the process steps to cause the computing system to:
determine whether all conditions of the first branch of the first rule definition are TRUE; and
update a second counter associated with the first rule definition and the first branch if all conditions of the first branch of the first rule definition are determined as TRUE.

3. A computing system according to claim 2, the one or more processors to execute the process steps to cause the computing system to:
determine whether all conditions of a second branch of the first rule definition are TRUE; and
update a third counter associated with the first rule definition and the second branch if all conditions of the second branch of the first rule definition are determined as TRUE.

4. A computing system according to claim 3, the one or more processors to execute the process steps to cause the computing system to:
modify an order of the first branch and the second branch in the rule definition based on a comparison of the first counter and the third counter.

5. A computing system according to claim 4, wherein the modified order orders the first branch and the second branch in the rule definition in descending order of the associated second counter and third counter.

6. A computing system according to claim 5, the one or more processors to execute the process steps to cause the computing system to:
determine whether a second condition of the first branch of a first rule definition is TRUE;
update a fourth counter associated with the first rule definition and the second condition of the first branch if the second condition is determined as TRUE; and
modify an order of the first condition and the second condition in the first branch in the rule definition, the modified order of the first condition and the second condition ordering the first condition and the second condition in ascending order of the associated first counter and fourth counter.

7. A computing system according to claim 1, the one or more processors to execute the process steps to cause the computing system to:
determine whether a second condition of the first branch of a first rule definition is TRUE;
update a second counter associated with the first rule definition and the second condition of the first branch if the second condition is determined as TRUE; and
modify an order of the first condition and the second condition in the first branch in the rule definition, the modified order of the first condition and the second condition ordering the first condition and the second condition in ascending order of the associated first counter and second counter.

8. A computer-implemented method comprising:
receiving an instruction to evaluate a rule definition, the rule definition associated with one or more branches, and each branch associated with one or more conditions;
determining whether a first condition of a first branch of the rule definition is TRUE; and
updating a first counter associated with the rule definition and the first condition of the first branch if the first condition is determined as TRUE.

9. A method according to claim 8, further comprising:
determining whether all conditions of the first branch of the rule definition are TRUE; and
updating a second counter associated with the rule definition and the first branch if all conditions of the first branch of the rule definition are determined as TRUE.

10. A method according to claim 9, further comprising:
determining whether all conditions of a second branch of the rule definition are TRUE; and
updating a third counter associated with the rule definition and the second branch if all conditions of the second branch of the rule definition are determined as TRUE.

11. A method according to claim 10, further comprising:
modifying an order of the first branch and the second branch in the rule definition based on a comparison of the first counter and the third counter.

12. A method according to claim 11, wherein the modified order orders the first branch and the second branch in the rule definition in descending order of the associated second counter and third counter.

13. A method according to claim 12, further comprising:
determining whether a second condition of the first branch of a first rule definition is TRUE;
updating a fourth counter associated with the first rule definition and the second condition of the first branch if the second condition is determined as TRUE; and
modifying an order of the first condition and the second condition in the first branch in the rule definition, the modified order of the first condition and the second condition ordering the first condition and the second condition in ascending order of the associated first counter and fourth counter.

14. A method according to claim 8, further comprising:
determine whether a second condition of the first branch of a first rule definition is TRUE;
update a second counter associated with the first rule definition and the second condition of the first branch if the second condition is determined as TRUE; and
modify an order of the first condition and the second condition in the first branch in the rule definition, the modified order of the first condition and the second condition ordering the first condition and the second condition in ascending order of the associated first counter and second counter.

15. A computing system comprising:
a storage system to store a plurality of rule definitions, each of the plurality of rule definitions is associated with one or more branches, and each branch associated with one or more conditions; and
a rule engine to:
determine whether a first condition of a first branch of a first rule definition is TRUE; and
update a first counter associated with the first rule definition and the first condition of the first branch if the first condition is determined as TRUE.

16. A computing system according to claim 15, the rule engine further to:
determine whether all conditions of the first branch of the first rule definition are TRUE; and
update a second counter associated with the first rule definition and the first branch if all conditions of the first branch of the first rule definition are determined as TRUE.

17. A computing system according to claim 16, the rule engine further to:
determine whether all conditions of a second branch of the first rule definition are TRUE; and
update a third counter associated with the first rule definition and the second branch if all conditions of the second branch of the first rule definition are determined as TRUE.

18. A computing system according to claim 17, the rule engine further to:
modify an order of the first branch and the second branch in the rule definition based on a comparison of the first counter and the third counter, wherein the modified order orders the first branch and the second branch in the rule definition in descending order of the associated second counter and third counter.

19. A computing system according to claim 18, the rule engine further to:
determine whether a second condition of the first branch of a first rule definition is TRUE;
update a fourth counter associated with the first rule definition and the second condition of the first branch if the second condition is determined as TRUE; and
modify an order of the first condition and the second condition in the first branch in the rule definition, the modified order of the first condition and the second condition ordering the first condition and the second condition in ascending order of the associated first counter and fourth counter.

20. A computing system according to claim 15, the rule engine further to:
determine whether a second condition of the first branch of a first rule definition is TRUE;
update a second counter associated with the first rule definition and the second condition of the first branch if the second condition is determined as TRUE; and
modify an order of the first condition and the second condition in the first branch in the rule definition, the modified order of the first condition and the second condition ordering the first condition and the second condition in ascending order of the associated first counter and second counter.
